(19) United States
(12) Patent Application Publication
(10) Pub. No.: US 2005/0219155 A1
(43) Pub. Date: Oct. 6, 2005

(54) Driving method of display panel

(75) Inventor: Hideto Nakamura, Yamanashi-ken (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 11/089,130

(22) Filed: Mar. 24, 2005

(30) Foreign Application Priority Data
Mar. 31, 2004 (JP) 2004-102800

(51) Int. Cl. G09G 3/28

(52) U.S. Cl. 345/60

(57) ABSTRACT

A driving method of a display panel which can display an image of high contrast and high quality is provided. A first resetting discharge to form wall charges is caused by applying a first reset pulse having a leading interval in which a voltage value increases in association with the lapse of time to row electrodes of the display panel. A second resetting discharge to adjust an amount of the wall charges is caused by applying a second reset pulse having a leading interval in which the voltage value reaches a predetermined voltage value to the row electrodes just before a start point of a voltage drop in a trailing interval of the first reset pulse.

### BACKGROUND OF THE INVENTION

1. Field of the Invention

The invention relates to a driving method of a display panel for displaying images.

2. Description of the Related Art

Nowadays, the AC type (alternating current discharge type) plasma display panel (PDP) has been put into practical use as a product of a thin display apparatus. Since each discharge cell corresponding to each pixel in the plasma display panel emits light by using a discharge phenomenon, it has only two states: a light-emitting state corresponding to a highest luminance level; and a light-off state corresponding to a lowest luminance level. Gradation driving using a subfield method is, therefore, executed to the plasma display panel in order to obtain a halftone display luminance corresponding to an input video signal.

In the gradation driving based on the subfield method, display driving for the video signal of one field is executed in each of a plurality of subfields to each of which the number of times of the light emission that is executed has been allocated. In the gradation driving, an addressing step and a sustaining step are sequentially executed in each subfield. In the addressing step, a selective discharge is selectively caused in each discharge cell in response to the input video signal and wall charges of a predetermined amount are formed (or the wall charges are erased). In the sustaining step, by repetitively applying sustaining pulses, only the discharge cells in which the predetermined amount of wall charges have been formed are made to repetitively perform a sustaining discharge and the light-emitting state accompanied by the discharge is sustained. Further, an initializing step is executed in which, in at least the head subfield, a resetting discharge is caused in all discharge cells by applying a reset pulse and an amount of wall charges remaining in all of the discharge cells is initialized (the predetermined amount of wall charges are formed or the wall charges are erased).

Since the resetting discharge, however, is not concerned with contents of an image to be displayed, the light emission associated by the discharge decreases contrast of the image. There has been proposed, therefore, a driving method whereby the resetting discharge is weakened by gently increasing a voltage in a leading interval of the reset pulse that is applied to forcibly allow all of the discharge cells to execute the resetting discharge, thereby reducing the light-emitting luminance-accompanied by the resetting discharge. Refer to FIG. 6 of Japanese Patent Kokai No. 2002-351394 (Patent Document 1). A variation occurs in the amount of wall charges which are formed in each discharge cell due to the weakened resetting discharge and there is a fear that the selective discharge in the addressing step is erroneously performed. In the driving disclosed in Patent Document 1, therefore, after the resetting discharge as mentioned above, a second resetting discharge is caused by applying a second reset pulse (RP2) having the same pulse voltage (Vs) as that of the sustaining pulse, thereby adjusting the amount of wall charges to a desired amount.

Since the pulse voltage of the reset pulse which is applied to cause the first resetting discharge is relatively high, however, the discharge is caused not only in the leading interval but also in the trailing interval. Due to the erroneous discharge, since it is difficult to initialize the amount of wall charges remaining in all of the discharge cells to the desired amount, such a problem that the erroneous discharge in the addressing step is caused and display quality is deteriorated occurs.

### SUMMARY OF THE INVENTION

The invention is made to solve the problems and it is an object of the invention to provide a driving method of a display panel which can display an image of high contrast and high quality.

According to a first aspect of the invention, there is provided a driving method of a display panel in which display cells serving as pixels are formed in crossing portions of a plurality of row electrode pairs corresponding to display lines and a plurality of column electrodes arranged so as to cross the row electrode pairs, comprising: a resetting step of initializing an amount of wall charges in each of the display cells; an addressing step of forming or erasing the wall charges in each of the display cells on the basis of an input video signal; and a sustaining step of allowing only the display cells in which the wall charges have been formed to emit light, wherein the resetting step includes a first resetting step of causing a first resetting discharge to form the wall charges between the row electrodes serving as a row electrode pair by applying a first reset pulse having a leading interval in which a voltage value increases in association with the elapse of time to the row electrodes and a second resetting step of causing a second resetting discharge to adjust the amount of the wall charges between the row electrodes serving as a row electrode pair by applying a second reset pulse having a leading interval in which a voltage value reaches a predetermined voltage value to the row electrodes just before a start point of a voltage drop in a trailing interval of the first reset pulse.

According to a second aspect of the invention, there is provided a driving method of a display panel in which display cells serving as pixels are formed in crossing portions of a plurality of row electrode pairs corresponding to display lines and a plurality of column electrodes arranged so as to cross the row electrode pairs, comprising: a resetting step of initializing an amount of wall charges in each of the display cells; an addressing step of forming or erasing the wall charges in each of the display cells on the basis of an input video signal; and a sustaining step of allowing only the display cells in which the wall charges have been formed to perform a sustaining discharge by alternately applying a sustaining pulse to each of the row electrodes in the row electrode pair, wherein the resetting step includes a first resetting step of causing a first resetting discharge to form the wall charges between the row electrodes serving as a row electrode pair by applying a first reset pulse having a leading interval in which the voltage value increases in association with the elapse of time and a trailing interval in which the voltage value decreases in association with the elapse of time to the row electrodes and a second resetting step of causing a second resetting discharge to adjust the amount of the wall charges between the row electrodes serving as a row electrode pair by applying a second reset pulse to the row electrodes just after the first reset pulse has been applied.

### BRIEF DESCRIPTION OF THE DRAWINGS

FIG. 1 is a diagram showing a construction of a plasma display apparatus to which a driving method of the invention is applied;

FIG. 2 is a diagram showing an internal construction of each of row electrode driving circuits 4 and 5;

FIG. 3 is a diagram showing an example of various driving pulses which are applied to a PDP 1 and applying timing of those pulses;

FIG. 4 is a diagram showing another example of the internal construction of each of row electrode driving circuits 4 and 5; and

FIG. 5 is a diagram showing another example of the various driving pulses which are applied to the PDP 1 and applying timing of those pulses.

### DETAILED DESCRIPTION OF THE PREFERRED EMBODIMENTS

A first resetting discharge to form wall charges is caused by applying a first reset pulse having a leading interval in which a voltage value increases in association with the elapse of time to row electrodes of a display panel and a second resetting discharge in which an amount of the wall charges is adjusted is caused by applying a second reset pulse having a leading interval in which the voltage value reaches a predetermined voltage value to the row electrodes just before a start point of a voltage drop in a trailing interval of the first reset pulse.

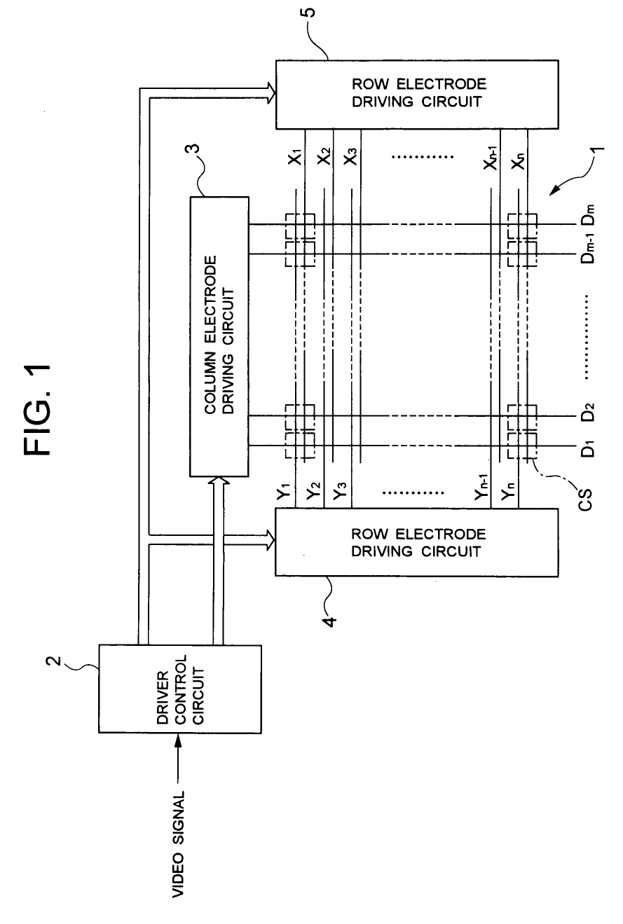

FIG. 1 is a diagram showing a schematic construction of a plasma display apparatus for gradation-driving a plasma display panel on the basis of a driving method according to the invention.

In FIG. 1, a PDP 1 as a plasma display panel has: a front transparent substrate (not shown) on which n row electrodes X₁ to Xₙ and n row electrodes Y₁ to Yₙ are alternately arranged in the X and Y directions; and a rear substrate (not shown) on which m column electrodes D₁ to Dₘ as address electrodes are formed. In the PDP 1, one display line of the PDP 1 is constructed by a pair of row electrodes (X, Y) which are adjacent to each other. That is, the first to nth display lines in the PDP 1 are formed by the row electrodes X₁ to Xₙ and the row electrodes Y₁ to Yₙ, respectively. A discharge space in which a discharge gas is enclosed is formed between the front transparent substrate and the back substrate. A discharge cell CS serving as a pixel is formed in each crossing portion of each row electrode pair and the column electrode including the discharge space.

A drive control circuit 2 forms various timing signals to gradation-drive the PDP 1 on the basis of a subfield method and supplies them to electrode driving circuits 4 and 5. The drive control circuit 2 also divides pixel data of each pixel based on an input video signal every bit, forms pixel data bits DB, and supplies the pixel data bits DB to a column electrode driving circuit 3 every display line (DB₁ to DBₘ).

The column electrode driving circuit 3 generates m pixel data pulses each corresponding to a logic level of each of the pixel data bits DB₁ to DBₘ and supplies them to the column electrodes D₁ to Dₘ of the PDP 1, respectively.

The row electrode driving circuits 4 and 5 generate various driving pulses in response to the various timing signals supplied from the drive control circuit 2 and applies them to one of the row electrodes Y₁ to Yₙ and X₁ to Xₙ of the PDP 1. According to the gradation driving based on the subfield method, one field period in the input video signal is divided into a plurality of subfields and the light emission driving is executed to each display cell every subfield.

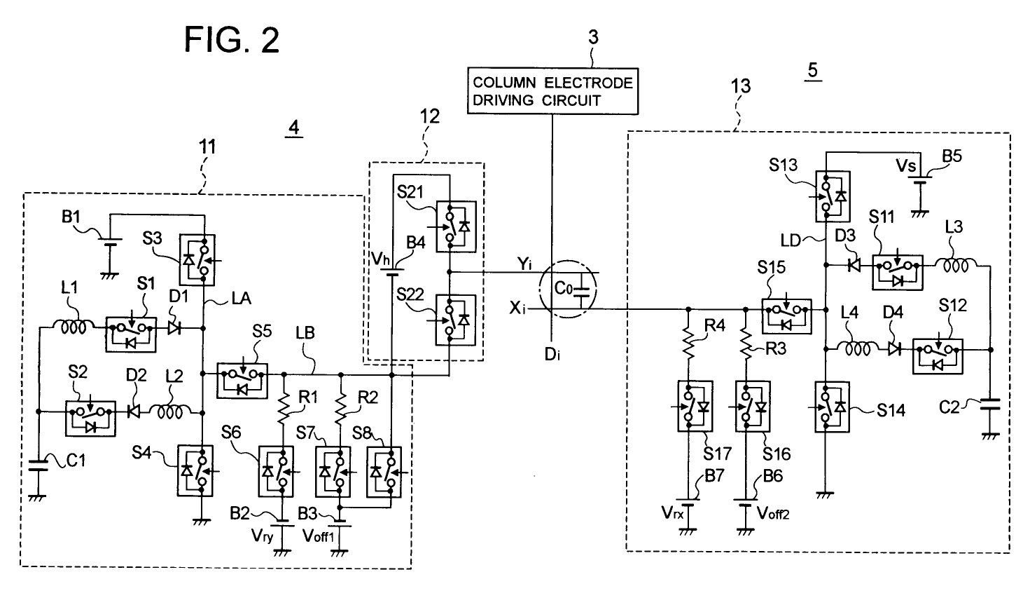

FIG. 2 is a diagram showing an internal construction of each of row electrode driving circuits 4 and 5.

The row electrode driving circuit 4 has a Y sustain driver 11 and a scan driver 12. The row electrode driving circuit 5 has an X sustain driver 13.

The Y sustain driver 11 has: coils L1 and L2; switching devices S1 to S8; diodes D1 and D2; resistors R1 and R2; a capacitor C1; and power sources B1 to B3. The scan driver 12 has switching devices S21 and S22 and a power source B4. The X sustain driver 13 has: coils L3 and L4; switching devices S11 to S17; diodes D3 and D4; resistors R3 and R4; a capacitor C2; and power sources B5 to B7. Each of the switching devices S1 to S8, S11 to S17, S21, and S22 has a parasitic diode as shown by a diode symbol in FIG. 2.

In the Y sustain driver 11, a positive terminal of the power source B1 is connected to a connection line LA through the switching device S3 and a negative terminal is connected to the ground. The power source B3 generates a voltage Vs. The switching device S4 is connected between the connection line LA and the ground. Further, a serial circuit comprising the diode D1, switching device S1, and coil L1 and a serial circuit comprising the coil L2, diode D2, and switching device S2 are connected to the ground side through the capacitor C1 in common. A terminal of the diode D1 on the capacitor C1 side is assumed to be an anode. A terminal of the diode D2 on the capacitor C1 side is connected as a cathode. The connection line LA is connected to a connection line LB to a negative terminal of the power source B4 of the scan driver 12 through the switching device S5. A negative terminal of the power source B2 is connected to the connection line LB through the switching device S6 and the resistor R1 and a positive terminal is connected to the ground. Similarly, a negative terminal of the power source B3 is connected to the connection line LB through the switching device S7 and the resistor R2 and a positive terminal is connected to the ground. The negative terminal of the power source B3 is also connected to the connection line LB only through the switching device S8. The power source B2 generates a voltage Vry. The power source B3 generates a voltage Voff1. The power source B4 generates a voltage Vh. Vh<Vs. The on/off operations of the switching devices S1 to S8 are controlled in accordance with the timing signals which are generated from the drive control circuit 2.

In the scan driver 12, a positive terminal of the power source B4 is connected to a row electrodes Yⱼ of the PDP 1 through the switching device S21. A negative terminal of the power source B4 connected to the connection line LB is connected to the row electrodes Yⱼ through the switching device S22. The on/off operations of the switching devices S21 and S22 are controlled in accordance with the timing signals which are generated from the drive control circuit 2.

In the X sustain driver 13, a positive terminal of the power source B5 is connected to a connection line LD through the switching device S13 and a negative terminal is connected to the ground. The power source B5 generates the voltage Vs. The switching device S14 is connected between the connection line LD and the ground. A serial circuit comprising the diode D3, switching device S11, and coil L3 and a serial circuit comprising the coil L4, diode D4, and switching device S12 are connected to the ground side through the capacitor C2 in common. A terminal of the diode D3 on the capacitor C2 side is assumed to be an anode. A terminal of the diode D4 on the capacitor C2 side is connected as a cathode. The connection line LD is connected to a row electrode Xⱼ of the PDP 1 through the switching device S15. A positive terminal of the power source B6 is connected to the row electrode Xⱼ through the switching device S16 and the resistor R3 and a negative terminal is connected to the ground. Similarly, a positive terminal of the power source B7 is connected to the row electrode Xⱼ through the switching device S17 and the resistor R4 and a negative terminal is connected to the ground. The power source B6 generates a voltage Voff2. The power source B7 generates a voltage Vrx. The on/off operations of the switching devices S11 to S17 are controlled in accordance with the timing signals which are generated from the drive control circuit 2.

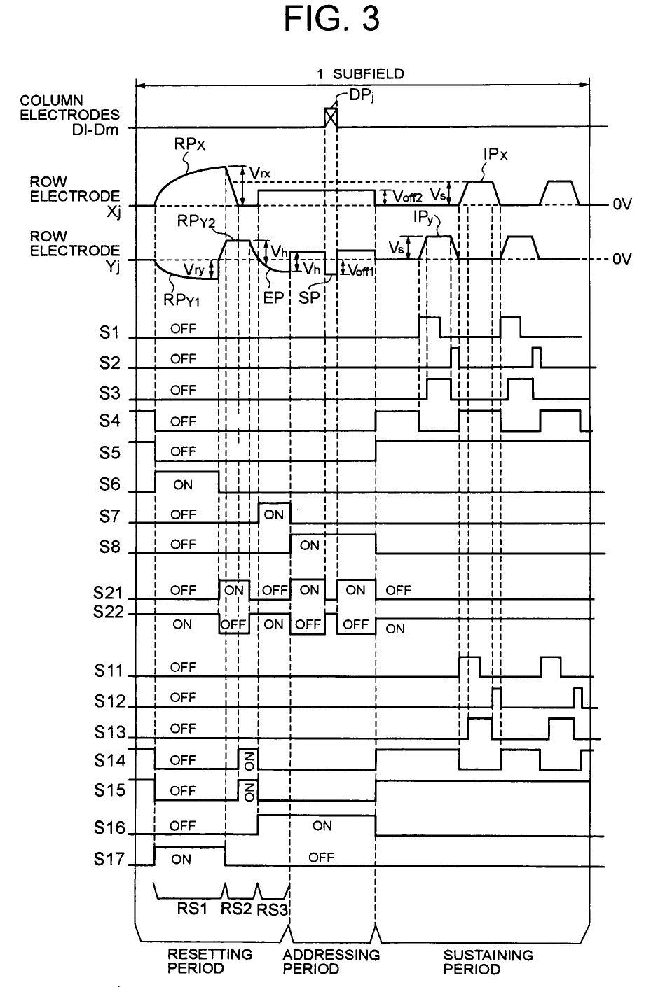

The operation of the plasma display apparatus as mentioned above will now be described with reference to a time chart of FIG. 3.

The time chart of FIG. 3 shows various driving pulses which are applied to the PDP 1 in one subfield among a plurality of subfields constructing each field when a selective write addressing system is used and applying timing of those driving pulses. The subfield is constructed by a resetting period for executing a resetting step, an addressing period for executing an addressing step, and a sustaining period for executing a sustaining step.

The resetting step comprises a first resetting step RS1, a second resetting step RS2, and a third resetting step RS3.

First, in the first resetting step RS1, the switching device S6 of the Y sustain driver 11 is turned on. Other switching devices of the Y sustain driver 11 are OFF. At this time, the switching device S21 of the scan driver 12 is OFF and the switching device S22 is ON. The X sustain driver 13 turns off all of the switching devices S11 to S16 and turns on the switching device S17. At this time, a current flows from the positive terminal of the power source B7 to the row electrode Xⱼ through the switching device S17 and the resistor R4, flows between the row electrodes Xⱼ and Yⱼ, and further flows from the row electrodes Yⱼ to the negative terminal of the power source B2 through the switching device S22, the resistor R1, and the switching device S6. Since a gap between the row electrodes Xⱼ and Yⱼ can be regarded as a capacitor, an electric potential of the row electrode Xⱼ increases gradually to the positive side and an electric potential of the row electrode Yⱼ increases gradually to the negative side. When the electric potential of the row electrode Yⱼ reaches −Vry, the Y sustain driver 11 switches the switching device S6 to OFF state, the switching device S21 to ON state, and the switching device S22 to OFF state, respectively. Since the positive terminal of the power source B4 is, consequently, connected to the row electrode Yⱼ through the switching device S21, the electric potential of the row electrode Yⱼ is shifted to the positive side and reaches 0V. A first reset pulse RPy1 having a pulse voltage −Vry of a negative polarity is formed. After that, when the electric potential of the row electrode Yⱼ increases gradually to the positive side and reaches Vh, the X sustain driver 13 switches the switching device S17 to OFF state. The electric potential of the row electrode Xⱼ, thus, decreases and a reset pulse RPx of a positive polarity is formed. By simultaneously applying the reset pulse RPy1 of the negative polarity and the reset pulse RPx of the positive polarity, a resetting discharge is caused between the row electrodes Xⱼ and Yⱼ. After the termination of the discharge, charges of the negative polarity are formed near the row electrode Xⱼ of a dielectric layer of the display cell and charges of the positive polarity are formed near the row electrode Yⱼ. In other words, the state where the charges of the different polarities are formed near the row electrodes Xⱼ and Yⱼ, that is, the state where what are called wall charges are formed is obtained.

In the next second resetting step RS2, when the electric potential of the row electrode Xⱼ reaches 0V, the X sustain driver 13 sets the switching devices S14 and S15 to ON state for a predetermined period. Since the row electrode Xⱼ is connected to the ground through the switching devices S14 and S15 for the predetermined period, the electric potential of the row electrode Xⱼ is maintained at 0V. Further, in the predetermined period, the scan driver 12 switches the switching device S21 to OFF state and the switching device S22 to ON state. Since the negative terminal of the power source B4 is, thus, connected to the row electrode Yⱼ through the switching device S22, the electric potential of the row electrode Yⱼ decreases gradually and a second reset pulse RPy2 of the positive polarity having the pulse voltage Vh is formed. In response to the supply of the second reset pulse RPy2, a discharge is caused between the row electrodes Xⱼ and Yⱼ. Charges of the positive polarity are formed near the row electrode Xⱼ of the dielectric layer of the display cell and charges of the negative polarity are formed near the row electrode Yⱼ. In this instance, an amount of wall charges is adjusted to a desired amount by the discharge.

In the next third resetting step RS3, the Y sustain driver 11 switches the switching device S7 to ON state. The X sustain driver 13 switches the switching device S16 to ON state. The current, consequently, flows from the positive terminal of the power source B6 to the row electrode Xⱼ through the switching device S16 and the resistor R3, flows between the row electrodes Xⱼ and Yⱼ, and further flows from the row electrode Yⱼ to the negative terminal of the power source B3 through the switching device S22, the resistor R2, and the switching device S7. The electric potential of the row electrode Xⱼ increases immediately to the positive side and reaches Voff2. Since the electric potential of the row electrode Yⱼ is influenced by the charges accumulated between the row electrodes Xⱼ and Yⱼ by the reset pulse RPy2, it increases gradually to the negative side and reaches −Voff1 and an all-erasing pulse EP is formed. That is, the all-erasing pulse EP of the negative polarity whose trailing shift is gentle is applied to the row electrode Yⱼ. An erasing discharge is caused between the row electrodes Xⱼ and Yⱼ in accordance with the supply of the all-erasing pulse EP. After the termination of the discharge, charges of the negative polarity are formed near the row electrode Xⱼ, charges of the positive polarity are formed near the row electrode Yⱼ, and charges of the positive polarity are formed near the electrode Dᵢ, respectively. In brief, the state where the charges of the same polarity remain near the row electrodes Xⱼ and Yⱼ and the charges are neutralized, that is, the state where the wall charges have been extinguished is obtained. After the level of the all-erasing pulse EP is saturated, the Y sustain driver 11 switches the switching device S7 to OFF state and the switching device S8 to ON state. Further, the scan driver 12 switches the switching device S21 to ON state and the switching device S22 to OFF state. Since the state where the power sources B4 and B3 are serially connected between the row electrodes Yⱼ and the ground so as to have the opposite polarities is, consequently, obtained, the electric potential of the row electrode Yⱼ is immediately shifted from −Voff1 of the negative polarity to the voltage (Vh−Voff1) of the positive polarity and the all-erasing pulse EP is extinguished. By the potential change of the row electrode Yⱼ, the resetting period is finished and the next addressing period is started.

In the addressing period, the column electrode driving circuit 3 converts the pixel data of each pixel based on the video signal into pixel data pulses DP₁ to DPₙ each having a voltage value corresponding to its logic level and sequentially supplies them to the column electrodes D₁ to Dₘ every row. The Y sustain driver 11 sequentially applies a scanning pulse SP of a negative voltage to the row electrodes Y₁ to Yₙ synchronously with timing of each of the pixel data pulses DP₁ to DPₙ. The switching device S21 is turned off and the switching device S22 is turned on synchronously with the supply of the pixel data pulses DPⱼ from the column electrode driving circuit 3. The negative potential −Voff of the negative terminal of the power source B3, therefore, is applied to the row electrode Yⱼ through the switching devices S8 and S22. In this instance, the electric potential of the row electrode Yⱼ is shifted from the electric potential (Vh−Voff1) of the positive polarity as mentioned above to the electric potential −Voff of the negative polarity and it is applied as a scanning pulse SP to the row electrode Yⱼ. An amplitude value of the scanning pulse SP is the same as that of the pulse voltage Vh of the second reset pulse RPy2. The switching device S21 is turned on and the switching device S22 is turned off synchronously with the stop of the supply of the pixel data pulse DPⱼ from the column electrode driving circuit 3. The electric potential (Vh−Voff) of the positive terminal of the power source B4 is applied to the row electrode Yⱼ through the switching device S21. After that, the scanning pulse SP is applied to each of row electrodes Yⱼ₊₁, . . . , Yₙ in this order synchronously with the supply of pixel data pulses DPⱼ₊₁, . . . , Dₙ from the column electrode driving circuit 3. In the display cell belonging to the row electrode to which the scanning pulse SP has been applied, when the pixel data pulse of the positive voltage is further simultaneously applied, a discharge is caused and the wall charges are increased to a level at which they are discharged by the supply of the sustaining pulse. In the display cell to which the pixel data pulse of the positive voltage is not applied although the scanning pulse SP has been applied, since no discharge is caused, the wall charges are not increased. In this instance, the display cell whose wall charges have been increased becomes the light-emitting display cell and the display cell whose wall charges remain as they are becomes the non-light-emitting display cell.

In the sustaining period, the switching devices S6 to S8, S16, S17, and S21 are turned off and the switching devices S4, S5, S14, S15, and S22 are turned on. The electric potential of the row electrode Yⱼ is, therefore, set to the ground potential of almost 0V by the turn-on of the switching devices S4 and S5 of the Y sustain driver 11 and the turn-on of the switching device S22 of the scan driver 12. In the X sustain driver 13, the electric potential of the row electrode Xⱼ is set to the ground potential of almost 0V by the turn-on of the switching devices S14 and S15. Subsequently, when the switching device S4 is turned off and the switching device S1 is turned on, the current reaches the row electrode Yⱼ through the coil L1, switching device S1, diode D1, switching device S5, and switching device S22 by the charges accumulated in the capacitor C1, flows in the capacitor component between the row electrodes Yⱼ and Xⱼ, and further flows to the ground through the switching devices S15 and S14. The capacitor component between the row electrodes Yⱼ and Xⱼ is, therefore, charged. In this instance, the electric potential of the row electrode Yⱼ increases gradually as shown in FIG. 3 by a time constant of the coil L1 and the capacitor component between the row electrodes Yⱼ and Xⱼ. That is, a leading interval of the pulse voltage in a sustaining pulse IPy (which will be explained hereinafter) is formed by the charges accumulated in the capacitor C1. Subsequently, the switching device S3 is turned on. The electric potential Vs of the positive terminal of the power source B1 is, thus, applied to the row electrode Yⱼ and the switching device S1 is turned off just after that. The switching device S3 is turned off after the lapse of a predetermined period and, at the same time, the switching device S2 is turned on and the current flows from the row electrode Yⱼ to the capacitor C1 through the switching device S22, switching device S5, coil L2, diode D2, and switching device S2 by the charges accumulated in the capacitor component between the row electrodes Yⱼ and Xⱼ. In this instance, the electric potential of the row electrodes Yⱼ decreases gradually as shown in FIG. 3 by a time constant of the coil L2 and the capacitor C1.

That is, since the charges accumulated in the capacitor component between the row electrodes Yⱼ and Xⱼ are collected into the capacitor C1, a trailing interval of the pulse voltage in the sustaining pulse IPy (which will be explained hereinafter) is formed. When the electric potential of the row electrode Yⱼ reaches almost 0V, the switching device S2 is turned off and the switching device S4 is turned on. By the above operation, the Y sustain driver 11 forms the sustaining pulse IPy having the pulse voltage Vs of the positive polarity as shown in FIG. 3 onto the row electrode Yⱼ. In the X sustain driver 13, after the extinction of the sustaining pulse IPy, the switching device S11 is turned on and the switching device S14 is turned off. When the switching device S14 is ON, the electric potential of the row electrode Xⱼ is set to the ground potential of almost 0V. When the switching device S14 is turned off and the switching device S11 is turned on, however, the current reaches the row electrode Xⱼ through the coil L3, switching device S11, diode D3, and switching device S15 by the charges accumulated in the capacitor C2, flows in the capacitor component between the row electrodes Yⱼ and Xⱼ, and further flows to the ground through the switching devices S22, S5, and S4. The capacitor component between the row electrodes Yⱼ and Xⱼ and is, therefore, charged. In this instance, the electric potential of the row electrode Xⱼ increases gradually as shown in FIG. 3 by a time constant of the coil L3 and the capacitor component between the row electrodes Xⱼ and Yⱼ. That is, a leading interval of the pulse voltage in a sustaining pulse IPx (which will be explained hereinafter) is formed by the charges accumulated in the capacitor C2. Subsequently, the switching device S13 is turned on. The voltage Vs of the positive terminal of the power source B5 is applied to the row electrode Xⱼ. The switching device S11 is turned off just after that. The switching device S13 is turned off after the lapse of a predetermined period and, at the same time, the switching device S12 is turned on and the current flows from the row electrode Xⱼ to the capacitor C2 through the switching device S15, coil L4, diode D4, and switching device S12 by the charges accumulated in the capacitor component between the row electrodes Xⱼ and Yⱼ. In this instance, the electric potential of the row electrodes Xⱼ decreases gradually as shown in FIG. 3 by a time constant of the coil L4 and the capacitor C2. That is, since the charges accumulated in the capacitor component between the row electrodes Yⱼ and Xⱼ are collected into the capacitor C2, a trailing interval of the pulse voltage in the sustaining pulse IPx (which will be explained hereinafter) is formed. When the electric potential of the row electrode Xⱼ reaches almost 0V, the switching device S12 is turned off and the switching device S14 is turned on. By the above operation, the X sustain driver 13 applies the sustaining pulse IPx having the pulse voltage Vs of the positive polarity as shown in FIG. 3 to the row electrode Xⱼ. In the residual portion of the sustaining period after the sustaining pulse IPx is applied to the row electrode Xⱼ, the sustaining pulse IPy and the sustaining pulse IPx are alternately formed and alternately applied to the row electrode Yⱼ and the row electrode Xⱼ. In this instance, each time the sustaining pulse IPy or IPx is applied, a sustaining discharge is caused in the display cell in which the wall charges have been formed and the light-emitting state accompanied by the sustaining discharge is maintained. The timing for applying the sustaining pulse IPx to the row electrode Xⱼ is not limited to the timing to the row electrode Xⱼ but the sustaining pulses IPx can be simultaneously applied to all of the row electrodes X₁ to Xₙ. The timing for applying the sustaining pulse IPy to the row electrode Yⱼ is not limited to the timing to the row electrode Yⱼ but the sustaining pulses IPy can be simultaneously applied to all of the row electrodes Y₁ to Yₙ.

In the resetting period, the pulse voltage of the first reset pulse RPx which is applied to the row electrode X to cause the first resetting discharge reaches Vrx as a peak voltage value and just before the pulse voltage starts to decrease from Vrx, the pulse voltage of the second reset pulse RPy2 is shifted to Vh as a peak voltage value.

Before an erroneous discharge is caused in the trailing interval of the first reset pulse RPx, therefore, a discharge for adjusting the wall charges according to the second reset pulse RPy2 is caused, so that an amount of wall charges in all of the display cells can be initialized to a desired amount. Even if the first resetting discharge is weakened, therefore, to realize the high contrast, the image of high display quality is displayed without causing the erroneous discharge.

Although the erroneous discharge is prevented by applying the second reset pulse RPy2 just before the voltage of the first reset pulse RPx trails in the embodiment, the erroneous discharge can be also prevented by gently shifting the voltage in the trailing interval of the first reset pulse RPx itself.

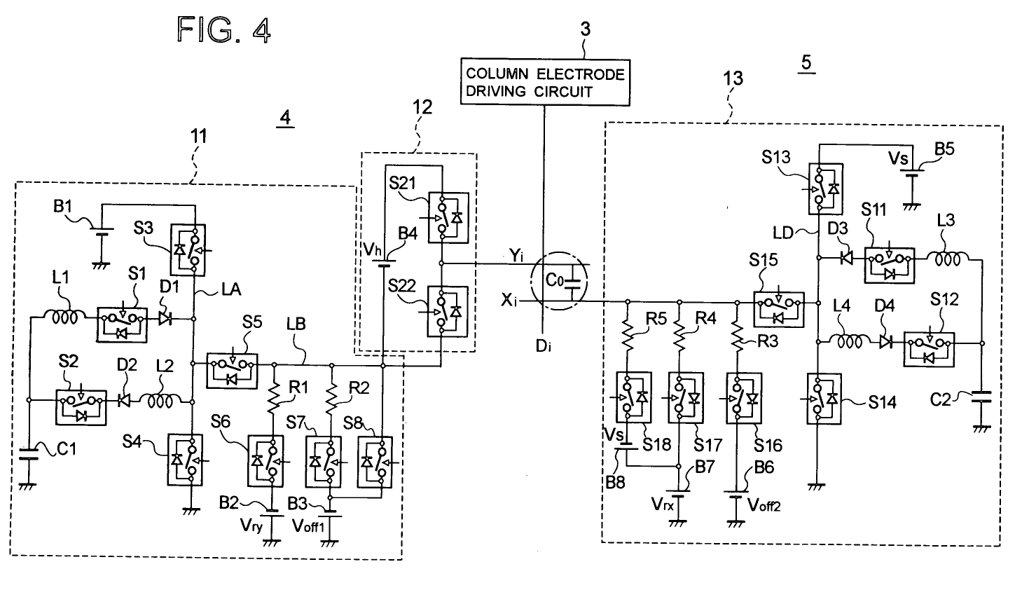

FIG. 4 is a diagram showing another example of the internal construction of each of row electrode driving circuits 4 and 5 which can form the reset pulse RPx whose voltage shift in the trailing interval is gentle.

In the construction shown in FIG. 4, a serial circuit comprising a resistor R5, a switching device S18, and a power source B8 is newly provided between the positive terminal of the power source B7 and the row electrode Xⱼ in the X sustain driver 13 shown in FIG. 2 and other circuit constructions are the same as those shown in FIG. 2.

The power source B8 is a DC power source for generating the same voltage Vs as that of the power sources B1 and B5. A positive terminal of the power source B8 is connected to the positive terminal of the power source B7 and a negative terminal is connected to the row electrode Xⱼ of the PDP 1 through the switching device S18 and the resistor R5.

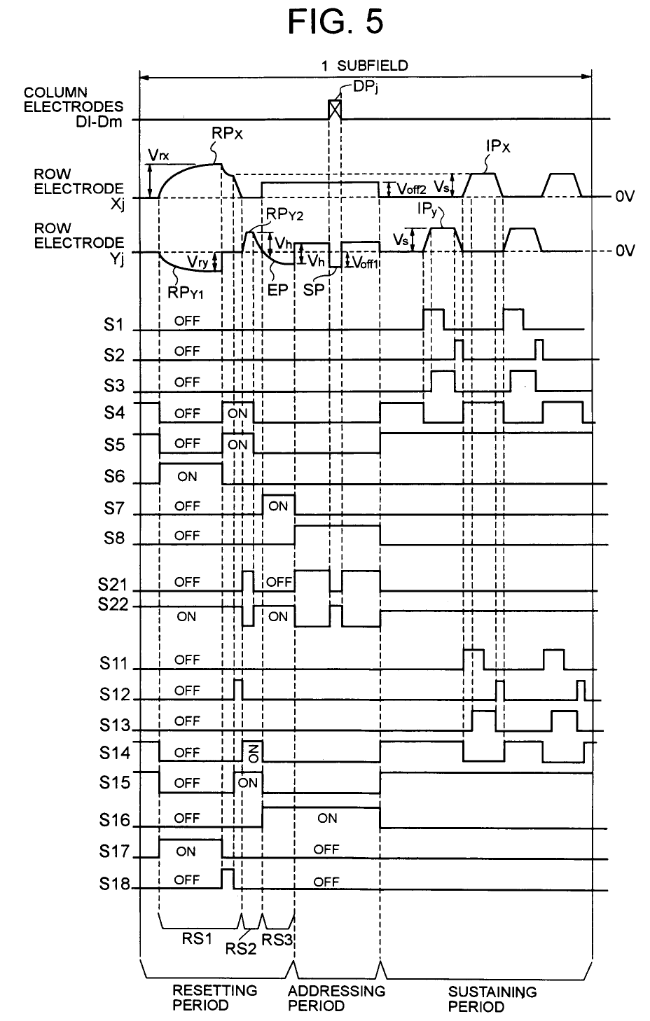

FIG. 5 shows the various driving pulses which are applied to the PDP 1 in one subfield and applying timing of those pulses in the case of using the construction shown in FIG. 4. In FIG. 5, since the operation in the third resetting step RS3 in each of the addressing period, sustaining period, and resetting period is substantially the same as that shown in FIG. 3, only the operation in the first resetting step RS1 and the second resetting step RS2 in the resetting period is extracted and will be explained hereinbelow.

First, in the first resetting step RS1, the switching device S6 of the Y sustain driver 11 is turned on. Other switching devices of the Y sustain driver 11 are OFF. At this time, the switching device S21 of the scan driver 12 are OFF and the switching device S22 is ON. The X sustain driver 13 turns off all of the switching devices S11 to S16 and turns on the switching device S17. At this time, a current flows from the positive terminal of the power source B7 to the row electrode Xⱼ through the switching device S17 and the resistor R4, flows between the row electrodes Xⱼ and Yⱼ, and further flows from the row electrodes Yⱼ to the negative terminal of the power source B2 through the switching device S22, the resistor R1, and the switching device S6. Since a gap between the row electrodes Xⱼ and Yⱼ can be regarded as a capacitor, the electric potential of the row electrode Xⱼ increases gradually to the positive side and the electric potential of the row electrode Yⱼ increases gradually to the negative side. When the electric potential of the row electrode Yⱼ reaches −Vry, the Y sustain driver 11 switches both of the switching devices S4 and S5 to ON state and the switching device S6 to OFF state. The row electrode Yⱼ is, thus, connected to the ground through the switching devices S4, S5, and S22, its electric potential is shifted to 0V, and the first reset pulse RPy1 having the pulse voltage −Vry of the negative polarity is formed. For the period of time, first, the X sustain driver 13 switches the switching device S18 to ON state. In place of the positive terminal of the power source B7, therefore, a negative terminal of the power source B8 is connected to the row electrode Xⱼ through the switching device S18 and the resistor R5, so that the electric potential of the row electrode Xⱼ decreases gently as shown in FIG. 5. That is, the former half portion of the trailing interval of the reset pulse RPx is formed. When the electric potential of the row electrode Xⱼ is equal to Vs as a peak voltage of the sustaining pulse IP, the X sustain driver 13 switches both of the switching devices S12 and S15 to ON state and the switching device S18 to OFF state, respectively. The current accompanied by the charges accumulated in the PDP 1 flows into the charge collecting capacitor C2 through the row electrode Xⱼ, switching device S15, coil L4, diode D4, and switching device S12, thereby charging the capacitor C2. By the charging operation, the electric potential of the row electrode Xⱼ decreases gradually. That is, since the charges accumulated in the capacitor component between the row electrodes Yⱼ and Xⱼ are collected into the capacitor C2, the latter half portion of the trailing interval of the reset pulse RPx is formed.

By the operation described above, in the trailing interval, the reset pulse RPx in which the voltage shift is gentle for a period of time (former half portion) until the pulse voltage decreases to Vs (peak voltage of the sustaining pulse IP) and, after that, the voltage is decreased more steeply than the former half portion is formed. In this instance, if the voltage shift when the pulse voltage decreases from Vrx to Vs is steep in the trailing interval of the reset pulse RPx, the erroneous discharge is caused. Since the voltage shift is, however, gentle as shown in FIG. 5, the erroneous discharge is suppressed.

In the next second resetting step RS2, when the electric potential of the row electrode Xⱼ decreases to 0V, the scan driver 12 switches the switching device S21 to ON state and the switching device S22 to OFF state, respectively. Since the voltage Vh of the positive terminal of the power source B4 is, thus, applied to the row electrode Yⱼ through the switching device S21, the electric potential of the row electrode Yⱼ rises as shown in FIG. 5 and reaches the voltage Vh. After that, the scan driver 12 switches the switching device S21 to OFF state and the switching device S22 to ON state, respectively. The Y sustain driver 11 further switches both of the switching devices S4 and S5 to OFF state. Since the negative terminal of the power source B4 is, therefore, connected to the row electrode Yⱼ through the switching device S22, the electric potential of the row electrode Yⱼ decreases gradually and the second reset pulse RPy2 of the positive polarity having the pulse voltage Vh is formed.

As mentioned above, in the driving shown in FIG. 5, in the former half portion of the trailing interval of the first reset pulse RPx, the pulse voltage is gently decreased to the voltage Vs that is equal to the peak voltage of the sustaining pulse IP, and in the latter half portion, the pulse voltage is decreased more steeply than the former half portion. At this time, in the trailing interval of the first reset pulse RPx, since the voltage is gently decreased for the period of time until at least the pulse voltage value reaches the voltage Vs that is equal to the peak voltage of the sustaining pulse IP, the discharge which is erroneously caused in the trailing interval is suppressed. As shown in FIG. 5, therefore, in the resetting period, even if the second reset pulse RPy2 is applied after the pulse voltage of the reset pulse RPx has been shifted from Vrx to 0V, the amount of wall charges in all of the display cells can be initialized to the desired amount.

In the embodiment, although the operation in each of the resetting period, addressing period, and sustaining period as shown in FIG. 3 has been described with respect to the driving operation based on the selective write addressing system as an example, the invention is not limited to it. In brief, the invention can be also similarly applied to the driving using what is called a selective erase addressing method whereby wall charges are preliminarily formed (resetting period) in all display cells and the wall charges formed in each of the display cells are selectively erased (addressing period) in accordance with the pixel data.

This application is based on Japanese Patent Application No 2004-102800 which in hereby incorporated by reference.

1. A driving method of a display panel in which display cells serving as pixels are formed in crossing portions of a plurality of row electrode pairs corresponding to display lines and a plurality of column electrodes arranged so as to cross said row electrode pairs, comprising:
a resetting step of initializing an amount of wall charges in each of said display cells;
an addressing step of forming or erasing said wall charges in each of said display cells on the basis of an input video signal; and
a sustaining step of allowing only said display cells in which said wall charges have been formed to emit light,
wherein said resetting step includes
a first resetting step of causing a first resetting discharge to form said wall charges between the row electrodes serving as said row electrode pair by applying a first reset pulse having a leading interval in which a voltage value increases in association with the elapse of time to said row electrodes and
a second resetting step of causing a second resetting discharge to adjust the amount of said wall charges between the row electrodes serving as said row electrode pair by applying a second reset pulse having a leading interval in which the voltage value reaches a predetermined voltage value to said row electrodes just before a start point of a voltage drop in a trailing interval of said first reset pulse.

2. A driving method of a display panel in which display cells serving as pixels are formed in crossing portions of a plurality of row electrode pairs corresponding to display lines and a plurality of column electrodes arranged so as to cross said row electrode pairs, comprising:
a resetting step of initializing an amount of wall charges in each of said display cells;
an addressing step of forming or erasing said wall charges in each of said display cells on the basis of an input video signal; and
a sustaining step of allowing only said display cells in which said wall charges have been formed to perform a sustaining discharge by alternately applying a sustaining pulse to each of the row electrodes in said row electrode pair,
wherein said resetting step includes
a first resetting step of causing a first resetting discharge to form said wall charges between the row electrodes serving as said row electrode pair by applying a first reset pulse having a leading interval in which a voltage value increases in association with the elapse of time and a trailing interval in which the voltage value decreases in association with the elapse of time to said row electrodes and
a second resetting step of causing a second resetting discharge to adjust the amount of said wall charges between the row electrodes serving as said row electrode pair by applying a second reset pulse to said row electrodes just after said first reset pulse has been applied.

3. A method according to claim 2, wherein
in said sustaining step, the trailing interval of said sustaining pulse is formed by activating a charge collecting circuit for collecting the charges accumulated in said display panel, and
in said first resetting step, in a former half portion of the trailing interval of said first reset pulse, the pulse voltage is gently decreased to the same voltage value as that of a peak voltage of said sustaining pulse in association with the elapse of time, and in a latter half portion of said trailing interval, the pulse voltage is decreased by activating said charge collecting circuit.
